(19) United States
(12) Patent Application Publication
(10) Pub. No.: US 2016/0305389 A1
(43) Pub. Date: Oct. 20, 2016

(54) VEHICLE CONTROL DEVICE

(71) Applicant: TOYOTA JIDOSHA KABUSHIKI KAISHA, Toyota-shi, Aichi-ken (JP)

(72) Inventor: Hirokazu KATO, Nisshin-shi (JP)

(73) Assignee: TOYOTA JIDOSHA KABUSHIKI KAISHA, Toyota-shi, Aichi-ken (JP)

(21) Appl. No.: 15/102,064

(22) PCT Filed: Dec. 9, 2014
(86) PCT No.: PCT/IB2014/002695

§ 371 Date: Jun. 6, 2016

(30) Foreign Application Priority Data
Dec. 13, 2013 (JP) 2013-258315

(51) Int. Cl. F02N 11/08; B60T 7/10

(52) U.S. Cl. CPC F02N 11/0822; B60T 7/10; F02N 11/0862; F02N 11/084; B60T 2201/06; F02N 2200/061; F02N 2200/102

(57) ABSTRACT

A vehicle control device includes: a brake hold unit that maintains brake force even when an operation of a brake pedal is released; an engine start unit that performs start request of an engine in a case that any one of a plurality of start conditions is satisfied; and a driving assistant unit that forcibly starts the engine when the engine is not started even if predetermined first start condition among the plurality of start conditions is satisfied in a case that the brake hold unit is- not in operation, and does not forcibly start the engine when the engine is not started even though predetermined second start condition among the first start condition is satisfied in a case that the brake hold unit is in operation.

### BACKGROUND OF THE INVENTION

1. Field of the Invention

The present disclosure relates to a vehicle control device.

2. Description of Related Art

With the attention on the environment issue, as one of methods to reduce the fuel consumption of a vehicle, a so-called idling stop system which enables an engine to be automatically stopped at idling during the vehicle is stopped is paid attention.

Generally, such an idling stop system allows the engine to be automatically stopped when predetermined stop conditions are satisfied, and allows the engine to be automatically started when predetermined start conditions are satisfied. One of the predetermined start conditions, for example, is “the operation of a brake pedal being released by a driver”.

The vehicle having such an idling stop system is provided with a driving assistant unit which forcibly starts the engine in the case that the engine is not started even when the predetermined start conditions have been satisfied. Moreover, in the case that the engine is not started from the engine stop state even when the start condition “the operation of the brake pedal being released by the driver” has been satisfied, the driving assistant unit is operated to forcibly start the engine. Thus, even in the case of occurrence of malfunction of sensors and/or communication abnormality of a control system or the like, it is possible to start the engine properly.

In addition, with the progress of the idling stop system technology, there is also known a vehicle technology by which the brake hydraulic pressure is maintained in the case that predetermined conditions are met at an uphill road or the like (for example, see Japanese Patent Application Publication No. 2013-071472 (JP 2013-071472A)). In this vehicle technology, the brake hydraulic pressure is maintained even after the operation of the brake pedal is released, until restart of the engine is completed. Thus, slippage of the vehicle at an uphill road or the like can be prevented.

In addition, in recent years, there is also known the vehicle equipped with a brake hold function aimed to reduce the driving burden of the driver, by this function, even when the driver releases the operation of the brake pedal, the brake force is maintained, and the engine will not be started even after the operation is released.

But in the vehicle having both the idling stop function and the brake hold function, there will be problems when the above driving assistant unit is operated to forcibly start the engine. That is to say, in such a vehicle, in the case that the brake hold function is in operation, the status that the engine is not started from the engine stop state even when the start condition “the operation of the brake pedal being released by the drive” has been satisfied means the engine is controlled according to the intention of the driver. Nevertheless, according to the above driving assistant unit, the engine will be forcibly started as the case that the engine is controlled by the conventional idling stop system.

It is not preferred that the engine is always forcibly started against the driver's intention in the case of the normal control as above described.

### SUMMARY OF THE INVENTION

Therefore, an object of the present disclosure is to provide a vehicle control device capable of not performing automatic start of the engine according to the intention of the driver.

An aspect of the invention relates to a vehicle control device. The vehicle control device, which includes a brake hold unit configured to maintain the brake force even when an operation of a brake pedal is released; an engine start unit configured to perform start request of an engine in a case that any one of a plurality of start conditions is satisfied; and a driving assistant unit configured to forcibly start the engine when the engine is not started even if predetermined first start conditions of the plurality of start conditions are satisfied in a case that the brake hold unit is not in operation and not to forcibly start the engine when the engine is not started even though predetermined second start conditions of the first start conditions are satisfied in a case that the brake hold unit is in operation.

According to the aspect of the invention, the vehicle control device capable of not performing automatic start of the engine according to the intention of the driver can be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view for illustrating a vehicle equipped with a control device according to an embodiment;

FIG. 2 is a functional block diagram for illustrating the system configuration of the control device according to an embodiment;

FIG. 3 is a flow chart for illustrating the process action performed by a brake ECU; and

FIG. 4 is a view for illustrating a specific area in the RAM of the brake ECU.

### DETAILED DESCRIPTION OF EMBODIMENTS

Hereinafter, embodiments will be described in detail with reference to the accompanying drawings. In addition, in the accompanying drawings, the same components are denoted with the same reference numerals, and the repeated description is omitted sometimes.

### The Configuration of a Control Device 100 of a Vehicle 1

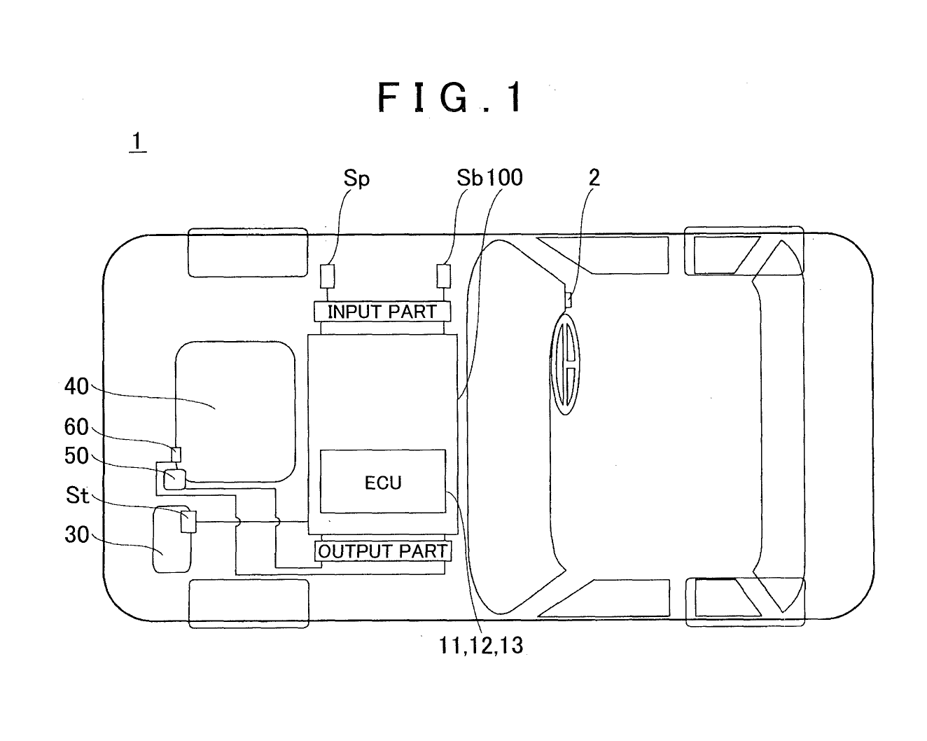

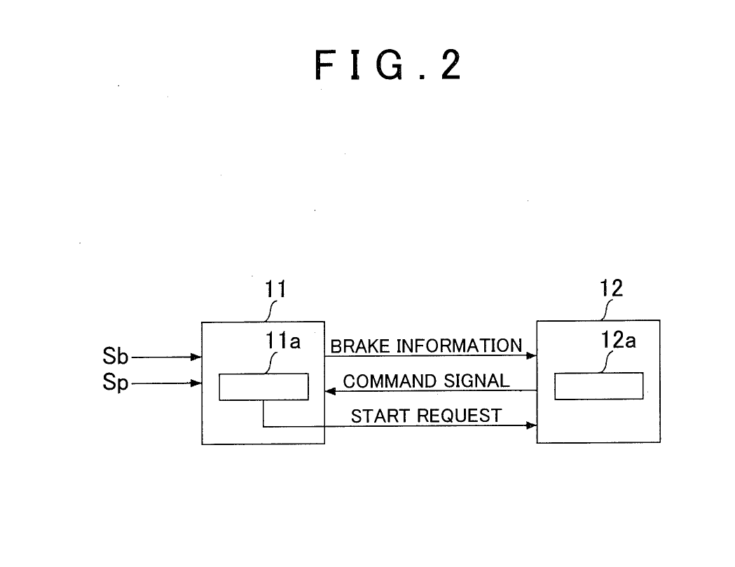

With reference to FIG. 1, the schematic configuration of the control device 100 of the vehicle 1 according to an embodiment will be described. FIG. 1 is a view for illustrating the vehicle 1 equipped with the control device 100 according to an embodiment. In addition, FIG. 2 is a functional block diagram for illustrating the system configuration of the control device 100.

The vehicle 1 is configured to include the control device 100, a battery 30, an engine 40, a hydraulic pressure pump 50, a tandem starter motor 60 and a brake hold standby button 2.

The brake hold standby button 2 is a button to be pressed by the driver in order to bring a brake hold unit into operation. When the standby button 2 is pressed and a brake pedal is stepped to stop the vehicle 1, a hold indicator is lighted. Thus, the operation and non-operation of the brake hold unit can be switched by selection.

The brake hold unit is a unit capable of maintaining the brake force during the vehicle is stopped, even when the operation of the brake pedal is released by the driver.

The control device 100 is a device for controlling the automatic start and automatic stop of the engine 40. For performing various operations, the control device 100 includes an input part, an output part and so on capable of inputting and outputting information.

As shown in FIG. 1, in order to obtain various brake information, the input part of the control device 100 is connected with a plurality of sensors. For example, a brake master cylinder pressure sensor Sb for detecting the pressure of the master cylinder, a stop switch Sp for detecting whether or not the brake pedal is pressed, and so on are connected thereto. Moreover, the remaining capacity of the battery 30 of the vehicle 1 is detected by a battery sensor St. In addition, the output part of the control device 100 is connected with the hydraulic pressure pump 50 and/or the tandem starter motor 60, and so on.

In particular, as shown in FIG. 1, the control device 100 is configured to include a brake ECU 11 for performing a brake control, an economic-run ECU 12 for performing an economic-run control, and an engine ECU 13 for performing control of the engine 40.

The brake ECU 11 is configured to include a CPU (Central Processing Unit), a ROM (Read Only Memory), and a RAM (Random Access Memory). Moreover, the output signal of the brake master cylinder pressure sensor Sb and/or status signals such as the ON/OFF signal of the stop switch Sp and so on are, inputted to the brake ECU 11.

The economic-run ECU 12 and the engine ECU 13 also are configured to include a CPU, a ROM and a RAM, similar with the brake ECU 11.

Whereby, the ECUs perform predetermined operation process by using the input information inputted from the input part, and then drive the hydraulic pressure pump 50 and/or the tandem starter motor 60 and so on connected with the output part based on the operation result.

(The controlling mechanism of the control device 100 of the vehicle 1) Next, the controlling mechanism of the vehicle 1 according to the present embodiment will be specifically described by using the accompanying drawings.

The control device 100 according to an embodiment includes a stop and start unit, a brake hold unit and an engine start unit.

The driver may express his intention on whether or not to bring the brake hold unit into operation by the on/off operation of the brake hold standby button 2 provided in the vehicle 1.

The stop and start unit is a unit for controlling the automatic stop (idling stop) of the engine and the automatic start (idling start) of the engine based on the operation status of the vehicle 1.

The stop and start unit, the brake hold unit and the engine start unit are implemented by the brake ECU 11, the economic-run ECU 12 and the engine ECU 13 included in the control device 100.

As shown in FIG. 1 and FIG. 2, when the detected signals of the brake master cylinder pressure sensor Sb and so on are input into the brake ECU 11, the detected signals are sent to the economic-run ECU 12 as brake information.

Then, based on the brake information sent from the brake ECU 11 to the economic-run ECU 12 and the information on whether or not the brake hold unit is in operation, the economic-run ECU 12 sends to the engine ECU 13 an instruction signal related to whether or not the driving of the engine 40 is allowed (start request). The start request is determined based on a plurality of start conditions stored in the economic-run ECU 12. Then, the engine ECU 13 instructs the tandem starter motor 60 according to the above start conditions. Thus, the engine 40 is properly controlled.

Here, the situation that the vehicle 1 having the stop and start unit is stopped and the engine 40 is stopped is considered.

In the case that the engine is controlled by the stop and start unit, when any one of the above plurality of start conditions is satisfied, the economic-run ECU 12 sends to the engine ECU 13 an instruction signal related to the start request of the engine 40. The plurality of start conditions for enabling the engine 40 to be started, for example, include “the operation of the brake pedal being released by the driver”.

In addition, the vehicle 1 is equipped with the driving assistant unit which forcibly starts the engine 40 in the case that the engine is not started even when a predetermined start condition has been met. The driving assistant unit is enabled by a judger 11a of the brake ECU 11.

In the case that the engine is not normally controlled by the stop and start unit, for example, in the case that the engine 40 is not started from the stop state thereof even when the start condition “the operation of the brake pedal being released by the driver” is satisfied, the driving assistant unit is enabled to operate to forcibly start the engine 40.

During the engine is normally controlled by the stop and start unit (the brake hold unit is not in operation), in the case that the start condition “the operation of the brake pedal being released by the driver” has been deemed as being satisfied based on the brake information, the economic-run ECU 12 sends a instruction signal for starting the engine to the engine ECU 13, that is, sends the start request of the engine 40. Then, the engine ECU 13, based on this start request, sends a drive signal to the tandem starter motor 60 to start the engine 40. In this case, the brake ECU 11 determines that the start of the engine 40 is being performed properly. The determination is made by the judger 11a included in the brake ECU 11. Whether or not the vehicle 1 is stopped, for example, can be determined based on the ON/OFF signal of the stop switch Sp and/or detected signals of a vehicle velocity meter (not shown) and so on inputted to the brake ECU 11 via the input part.

In addition, during the engine is normally controlled by the above stop and start unit, there is a situation that the engine is not started even when the start condition “the operation of the brake pedal being released by the driver” is satisfied. For example, sometimes, signals cannot be sent to the tandem starter motor 60 due to some reasons such as malfunction of the sensors and/or communication abnormality of the control system and so on, and in this case, the engine 40 is not started. In this case, the driving assistant unit is enabled to operate to forcibly start the engine 40.

In particular, the driving status of the engine 40 is monitored by the economic-run ECU 12, and the signals related to the driving status is sent from the economic-run ECU 12 to the brake ECU 11. By doing so, in addition to the information about the driving status of the engine 40, the brake ECU 11 determines whether or not the engine 40 is being properly controlled also based on the brake information and the information on whether or not the brake hold unit is in operation. The determination is made by the judger 11a included in the brake ECU 11. Moreover, in the case that the judger, 11a determines that some communication abnormality or so on occurs in the control system based on the above determined result, the driving assistant unit is enabled to operate to forcibly start the engine 40.

On the other hand, in the vehicle equipped with the idling stop system, in the case that the brake hold unit is in operation, in the case that the engine 40 is not started even when the start condition “the operation of the brake pedal being released by the driver” is satisfied, the driving assistant unit will not be enabled to operate, and the engine 40 will not be started.

In this case, the brake hold unit operates normally, and the engine is properly controlled, therefore, even though the start condition “the operation of the brake pedal being released by the driver ” is satisfied, the engine 40 will not be started automatically, and the judger 11a will not enable the driving assistant unit to operate.

This is because, based on the information about the driving status of the engine 40, the brake information and the information on whether or not the brake hold unit is in operation, the engine 40 is determined to be under normal control. As a result, the brake force is maintained.

As above, during the engine is normally controlled by the stop and start unit (the brake hold unit is not in operation), in the case that the engine 40 is not started even when the start condition “the operation-of the brake pedal being released by the driver” is satisfied, contrary to the driver's intention, the judger 11a enables the driving assistant unit to operate. Then, the engine 40 is forcibly started. This is because in this case, it is determined that some abnormality such as communication abnormality in the control system or the like occurs.

On the other hand, in the case that the brake hold unit is in operation, when the engine 40 is not started automatically even though the start condition “the operation of the brake pedal being released by the driver” is satisfied, the driving assistant unit is not enabled to operate. That is, in this case, it is possible to enable the brake hold unit for maintaining the brake force to normally operate.

In addition, even in the case that the brake hold unit is in operation, and when the engine 40 is not started automatically even though a start condition other than “the operation of the brake pedal being released by the driver” is satisfied, it is also possible to enable the driving assistant unit to operate. This is because even when the brake hold unit is in operation, sometimes it is necessary to start the engine 40, as described in detail later.

As above, even when different units such as the unit for automatically starting the engine after the operation of the brake pedal is released and the unit for maintaining the brake force after the operation of the brake pedal is released are equipped, the control device 100 can enable or disable the driving assistant unit to operate according to whether or not the brake hold unit is in operation. Thus, rather than the engine is always forcibly started against the driver's intention, the engine 40 can be properly controlled according to the driver's intention.

### Control Action of the Brake ECU 11

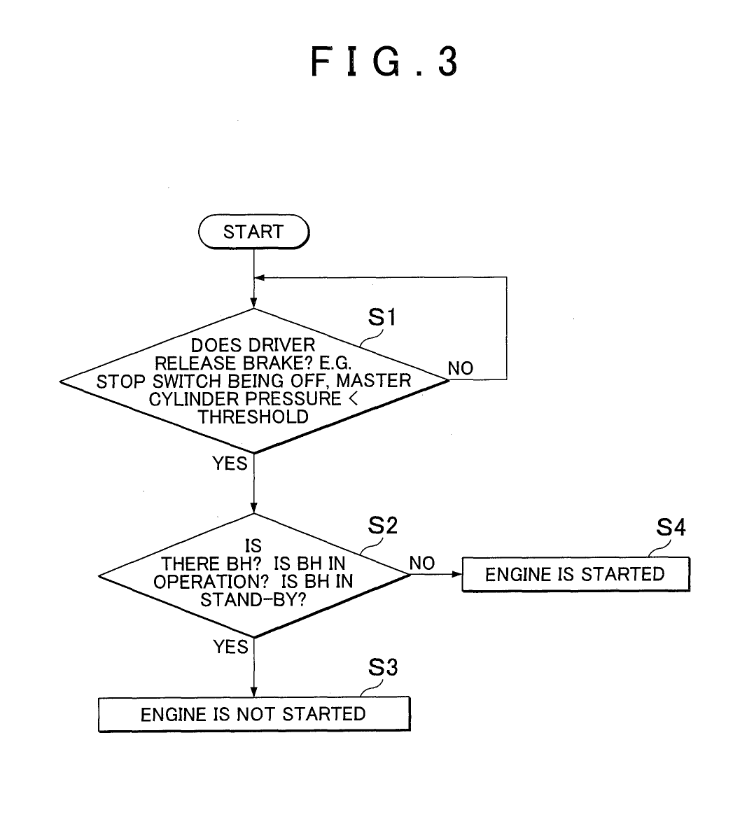

Next, the control action of the brake ECU 11 will be described by using the flow chart of FIG. 3. FIG. 3 is a flow chart for illustrating the process action of the brake ECU 11.

Firstly, in the step S1, the judger 11a of the brake ECU 11 determines whether or not the operation of the brake pedal is released by the driver. For example, in the case that the condition that the stop switch Sp is in OFF state and the brake master cylinder pressure is lower than a predetermined threshold is satisfied, it is determined that the driver releases the operation of the brake pedal.

In the step S1, in the case that the judger 11a determines “the operation of the brake pedal being released by the driver” (the step S1, YES), proceed to the step S2. In the step S2, the brake ECU 11 performs the determination for “whether or not there is the brake hold unit (BH)”, “confirmation on the brake hold unit being in operation”, and “confirmation on the brake hold unit being in standby”. That is, it is determined whether or not the brake hold unit is in operation. This determination is made by the judger 11a included in the brake ECU 11.

Here, “whether or not there is the brake hold unit” is a determination condition for confirming whether or not the vehicle 1 includes the brake hold unit.

In addition, “confirmation on the brake hold unit being in standby” is a determination condition for confirming whether or not the driver expresses the intention to bring the brake hold unit into operation. When it is intended to enable the brake hold unit to operate, the drive will press the brake hold standby button 2 provided in the vehicle 1. This state is referred to as “brake hold unit standby state”. In addition, in travelling, the brake hold standby button 2 basically is in OFF state, and is, switched from OFF state to ON state according to the driver's intention.

As above described, in the brake ECU 11, in addition to the “confirmation on the brake hold unit being in operation”, the determination is also performed for confirming “whether or not there is the brake hold unit” and “the brake hold unit being in standby”.

Confirming the brake hold unit being in operation by the three determination conditions is for reliably determining whether or not the brake hold unit is in operation. In addition, in the case that the vehicle 1 does not include the brake hold unit, it is also possible to cause the judger 11a not to perform the determination for confirming whether or not the brake hold unit being in operation, to shorten the process time for control.

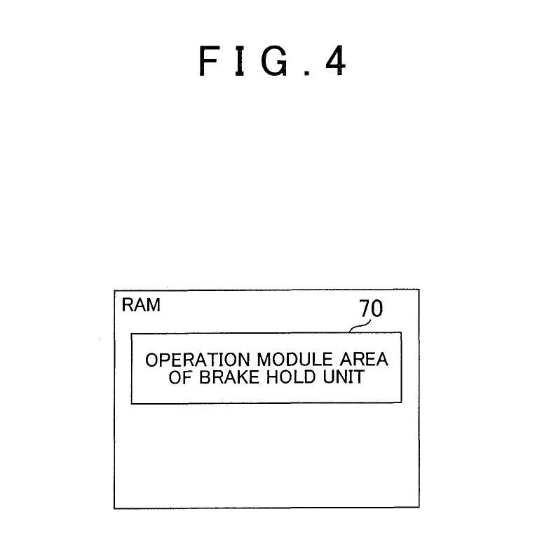

The determination on whether or not the brake hold unit being in operation is made in the RAM of the brake ECU 11. As shown in FIG. 4, the RAM of the brake ECU 11 includes an operation module area 70 of the brake hold unit (specific area) for performing the confirmation on “whether or not the brake hold unit being in operation”. In this specific area 70, the determination is performed for confirming whether “the brake hold unit being in operation” is in ON state or in OFF state.

But on the assumption that the determination for “confirmation on the brake hold unit being in operation” is performed only based on whether or not a flag for “the brake hold unit being in operation” in the specific area 70 of the RAM is met, there will be a problem.

For example, in the case that failure such as system abnormality or the like occurs in the RAM in the brake ECU 11, although the brake hold unit is not enabled to operate, it is possible that the flag for “the brake hold unit being in operation” is met. Therefore, the above three conditions are used as judging objects, such that the engine 40 is properly controlled.

Moreover, in the case that all the three conditions are satisfied, it is determined that the brake hold unit is in operation, and in the step S3, the control that the automatic start of the engine 40 is not performed is set. That is, even when the start condition “the operation of the brake pedal being released by the driver” has been satisfied, the economic-run ECU 12 does not send the instruction signal about the start request of the engine 40 to the engine ECU 13, and the stop state of the engine 40 is maintained. In this case, even when the engine 40 is not automatically started, the driving assistant unit is not enabled to operate.

On the other hand, in the case that a certain condition of the above three conditions is not satisfied (the step S2, NO), in the step S4, the engine 40 is automatically started. That is, the economic-run ECU 12 sends the instruction signal about the start request of the engine 40 to the engine ECU 13. At this time, in the case that the engine 40 is not automatically started, the driving assistant unit is enabled to operate to forcibly start the engine 40.

In this case, given that the engine 40 is not started due to the failure of the sensors and/or communication abnormality of the control system and so on, the driving assistant unit is enabled to operate by the judger 11a accordingly.

In addition, even when the brake hold unit is in operation, and sometimes, it is necessary to start the engine 40 (the start request of the engine 40 is performed). For example, a situation is assumed that the temperature in the summer or the like, especially indoors, rises. In addition, there is also a situation that the remaining capacity of the battery is not sufficient due to overuse of the electric power, and there is also a situation that the engine 40 is preferably started in order to charge the battery. Further, there is also a situation that the engine is preferably started when the brake hydraulic pressure becomes equal to or less than a predetermined value. Thus, the engine 40 can be more properly controlled. In addition, these start conditions also include the start conditions for starting the engine 40 in the case that the engine is normally controlled by the stop and start unit (the brake hold unit is not in operation).

Therefore, the status of the air conditioner of the vehicle 1, the remaining capacity of the battery, the brake hydraulic pressure, and so on also can be monitored. Thereby, even in the case that the driver expresses his intention to enable the brake hold unit to operate and releases the operation of the brake pedal, the automatic start of the engine 40 may be properly performed according to the status of the vehicle 1 and/or the internal apparatus, or the like.

As above, the preferred embodiments of the present invention have been described in detail, but the present invention will not be limited to the above embodiments, and may be applied to various vehicles 1 performing the stop and start control. In this case, the configurations of the above embodiments can be modified by combining other elements therewith without departing the scope of the purpose of the present invention, and can be properly determined according to the application thereof.

In the present embodiment, the following situation has been exemplified for illustration: in the case that the engine is normally controlled by the stop and start unit, when the engine 40 is not started even though the start condition “the operation of the brake pedal being released by the driver” is satisfied_{;} the driving assistant unit is enabled to operate to forcibly start the engine 40, but the present invention is not limited thereto.

For example, it is possible that, in the case that the engine 40 is not started after a predetermined first start condition is satisfied, the control device 100 also enables the driving assistant unit to operate to forcibly start the engine 40.

Alternatively, it is also possible that, in the case that the engine 40 is not started after the predetermined first start condition is satisfied, the driving assistant unit is not enabled to operate.

The predetermined first start condition(s) is one or more preset start conditions, and may be, for example, some or all of the start conditions including the condition “the operation of the brake pedal being released by the driver”.

In particular, it is possible that, in the case that the engine 40 is not started after the start condition “the remaining capacity of the battery being not sufficient” is satisfied, the control device 100 also enables the driving assistant unit to operate to forcibly start the engine 40. In addition, it is also possible that, in the case that the engine 40 is not started after the start condition “the indoor temperature rising” is satisfied, the control device 100 does not enable the driving assistant unit to operate.

In addition, in the present embodiments, the following example has been illustrated: during the brake hold unit is in operation, even in the case that the engine 40 is not started after the start condition “the operation of the brake pedal being released by the driver” is satisfied, the driving assistant unit is not enabled to operate, that is, the engine 40 is not forcibly started, but it is not limited thereto.

For example, it is also possible that, during the brake hold unit is in operation, in the case that the engine 40 is not started after a predetermined second start condition is satisfied, the control device 100 does not enable the driving assistant unit to operate.

Alternatively, it is also possible that, during the brake hold unit is in operation, in the case that the engine 40 is not started after the predetermined second start condition is satisfied, the control device 100 enables the driving assistant unit to operate to forcibly start the engine 40.

The predetermined second start condition(s) is one or more preset start conditions, and may be, for example, some or all of the first start conditions.

In particular, it is also possible that, during the brake hold unit is in operation, even in the case that the engine 40 is not started after the start condition “the indoor temperature rising” is satisfied, the control device 100 will not enable the driving assistant unit to operate. In addition, it is also possible that, during the brake hold unit is in operation, in the case that the engine 40 is not started after the start condition “the remaining capacity of the battery being insufficient” is satisfied, the control device 100 enables the driving assistant unit to operate to forcibly start the engine 40.

In addition, in the above embodiments, the determination of the start condition “the operation of the brake pedal being released by the driver” is performed according to whether or not the stop switch is in OFF state and whether or not the brake master cylinder pressure is lower than a predetermined threshold, but it is not limited thereto. For example, the operation status of the brake pedal by the driver could also be determined according to the wheel cylinder pressure and/or the press force value of the brake pedal.

In addition, in the case of the present embodiments, the judger 11a of the brake ECU 11 is communicatively connected with a judger 12a of the economic-run ECU 12 so as to transmit and receive information via communication, but it is not limited thereto. For example, the two judgers 11a, 12a can be integrated into a comprehensive judger to make a determination without such communication. But, on the assumption that communication abnormality or the like occurs in the control system, transmission and reception via communication is preferred because the abnormality can be more easily identified.

In addition, according to the present embodiments, the determination for confirming “the brake hold unit being in operation” can be performed based on the three conditions, i.e., “ whether or not there is a brake hold unit”, “confirmation on the brake hold unit being in operation” and “confirmation on the brake hold unit being in standby”, but it is not limited thereto. Other conditions other than these three conditions can be added to perform the determination for confirming whether or not the brake hold unit is in operation. Further, the determination for confirming “the brake hold unit being in operation” may also be performed simply by “confirmation on the brake hold unit being in operation”.

1. A vehicle control device, comprising:
a brake hold unit configured to maintain brake force even when an operation of a brake pedal is released;
an engine start unit configured to perform start request of an engine in a case that any one of a plurality of start conditions is satisfied; and
a driving assistant unit configured to forcibly start& the engine when the engine is not started even if predetermined first start condition among the plurality of start conditions is satisfied in a case that the brake hold unit is not in operation, and does not forcibly start the engine when the engine is not started even though predetermined second start condition of the first start condition is satisfied in a case that the brake hold unit is in operation.

2. The vehicle control device according to claim 1, wherein
the plurality of start conditions and the first start condition at least include the release of the operation of the brake pedal,
in the case that the brake hold unit is in operation, the engine start unit does not perform the start request of the engine due to the release of the operation of the brake pedal, and
the second start condition includes the release of the operation of the brake pedal.

3. The vehicle control device according to claim 1, wherein
the second start condition at least include the release of the operation of the brake pedal, and in the case that the brake hold unit is in operation, when the engine is not started even though the condition of the release of the operation of the brake pedal is satisfied, if any one of the second start conditions other than the release of the operation of the brake pedal is satisfied, the engine is forcibly started.

4. The vehicle control device according to claim 1, wherein
the first start condition is all or some of the plurality of start conditions, and at least include the release of the operation of the brake pedal,
in the case that the brake hold unit is not in operation, when the engine is not started even if any one of the first start condition is satisfied, the engine is forcibly started.
